(19) United States
(12) Patent Application Publication
(10) Pub. No.: US 2025/0189841 A1
(43) Pub. Date: Jun. 12, 2025

(54) DISPLAY PANEL AND DISPLAY DEVICE

(71) Applicant: TCL CHINA STAR OPTOELECTRONICS TECHNOLOGY CO., LTD., Shenzhen (CN)

(72) Inventors: Hongxun ZHU, Shenzhen (CN); Haojie LU, Shenzhen (CN); Jian WU, Shenzhen (CN); Guining REN, Shenzhen (CN); Heng WEI, Shenzhen (CN); Xin LIU, Shenzhen (CN); Weiwei ZHANG, Shenzhen (CN)

(73) Assignee: TCL CHINA STAR OPTOELECTRONICS TECHNOLOGY CO., LTD., Shenzhen (CN)

(21) Appl. No.: 18/972,782

(22) Filed: Dec. 6, 2024

(30) Foreign Application Priority Data
Dec. 7, 2023 (CN) 202311690653.2

(51) Int. Cl. G02F 1/1335; G02F 1/1339

(52) U.S. Cl. CPC G02F 1/133514; G02F 1/133512; G02F 1/13394

(57) ABSTRACT

A display panel includes a first substrate and a second substrate arranged opposite to each other, and a first color resistor layer, a second color resistor layer, at least one first spacer and at least one second spacer arranged between the first and second substrates. The first color resistor layer includes at least one first color resistor and at least one second color resistor. The second color resistor layer includes at least one third color resistor. The first spacer includes a first unit located on a side of the first substrate close to the second substrate and including a first color resistor portion including a same material as that in one of the first and second color resistors. The second spacer includes a second unit including a second color resistor portion including a same material as that in one of the first, second, and third color resistors.

### CROSS-REFERENCE TO RELATED APPLICATION

This application claims priority to and the benefit of Chinese Patent Application No. 202311690653.2 filed on Dec. 7, 2023, the disclosure of which is incorporated herein by reference in its entirety.

### TECHNICAL FIELD

The present disclosure relates to display technologies, and in particular, to a display panel and a display device.

### BACKGROUND

Generally, in a display panel (e.g., a liquid crystal display panel), spacers of different heights are provided between a first substrate and a second substrate for controlling uniformity of a spacing between the first substrate and the second substrate. As shown in FIGS. 1 and 2, spacers 150′ and 160′ of different heights are formed on the same side of the substrate. However, in order to form spacers of different heights, it is necessary to adopt a complicated process. Thus, it is difficult to reduce costs and increase the spacing between the first substrate and the second substrate as desired for products.

### SUMMARY

According to one or more embodiments of the present disclosure, a display panel includes: a first substrate; a second substrate arranged opposite to the first substrate; a first color resistor layer located on a side of the first substrate close to the second substrate, the first color resistor layer including at least one first color resistor and at least one second color resistor; a second color resistor layer located on a side of the second substrate close to the first substrate, the second color resistor layer including at least one third color resistor; at least one first spacer arranged between the first substrate and the second substrate, the first spacer including a first unit located on the side of the first substrate close to the second substrate; at least one second spacer arranged between the first substrate and the second substrate, the second spacer including a second unit, in a first direction perpendicular to each of the first substrate and the second substrate, a height of the first unit is greater than a height of the second unit; and the first unit includes a first color resistor portion including a same material as that in one of the first color resistor and the second color resistor, and the second unit includes a second color resistor portion including a same material as that in one of the first color resistor, the second color resistor, and the third color resistor.

According to one or more embodiments of the present disclosure, a display device includes the display panel as mentioned above.

### BRIEF DESCRIPTION OF THE DRAWINGS

FIG. 1 is a schematic diagram of a first structure of an existing display panel.

FIG. 2 is a schematic diagram of a second structure of an existing display panel.

FIG. 3 is a schematic diagram of a first structure of a display panel according to one or more embodiments of the present disclosure.

FIG. 4 is a schematic diagram of a second structure of a display panel according to one or more embodiments of the present disclosure.

FIG. 5 is a schematic diagram of a third structure of a display panel according to one or more embodiments of the present disclosure.

FIG. 6 is a schematic structural diagram of a display device according to one or more embodiments of the present disclosure.

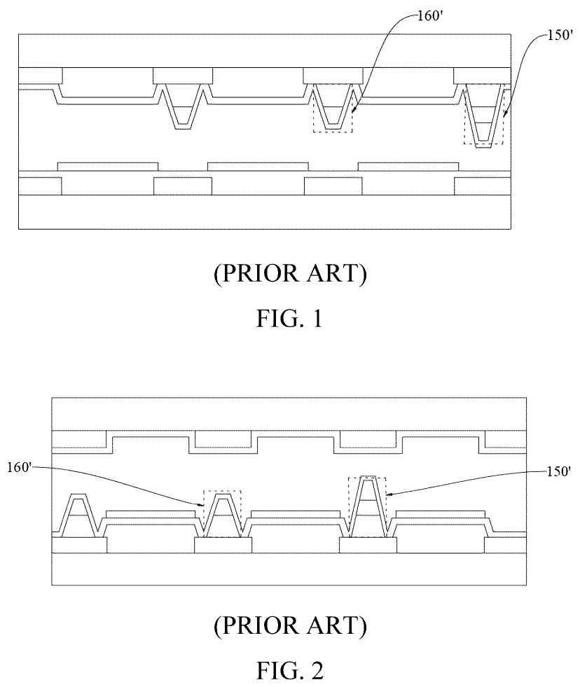

### DETAILED DESCRIPTION

The technical solution in the embodiments of the present disclosure will be clearly and completely described with reference to the accompanying drawings. It will be apparent that the described embodiments are only part of the embodiments of the present disclosure, and not all of them. Based on the embodiments in the present disclosure, all other embodiments obtained by the skilled person in the art without involving any inventive effort are within the scope of the present disclosure. In addition, it should be understood that the described embodiments are only to illustrate and explain the present disclosure, but not intended to limit the present disclosure. In the present disclosure, unless otherwise stated, locative words used such as “upper” and “lower” generally refer to the upper and lower directions of the device in actual use or working state, and specifically refer to the drawing directions in the drawings; and “inner” and “outer” refer to the outline of the device.

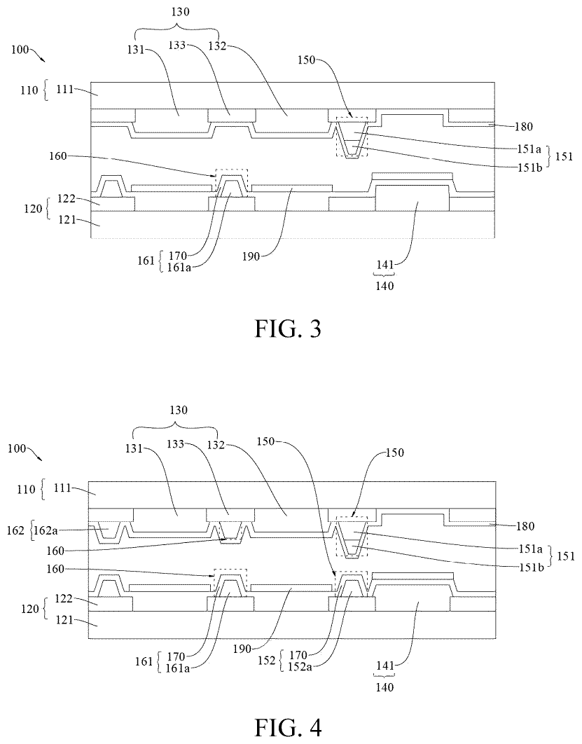

Referring to FIGS. 3 to 5, one or more embodiments of the present disclosure provide a display panel 100, including:
a first substrate 110;
a second substrate 120 arranged opposite to the first substrate 110;
a first color resistor layer 130 located on a side of the first substrate 110 close to the second substrate 120, the first color resistor layer 130 including at least one first color resistor 131 and at least one second color resistor 132;
a second color resistor layer 140 located on a side of the second substrate 120 close to the first substrate 110, the second color resistor layer 140 including at least one third color resistor 141;
at least one first spacer 150 arranged between the first substrate 110 and the second substrate 120, the first spacer 150 including a first unit 151 located on the side of the first substrate 110 close to the second substrate 120; and
at least one second spacer 160 arranged between the first substrate 110 and the second substrate 120, the second spacer 160 including a second unit 161.

In a first direction being perpendicular to each of the first substrate 110 and the second substrate 120, a height of the first unit 151 is greater than a height of the second unit 161.

The first unit 151 includes a first color resistor portion 151a including a same material as that in one of the first color resistor 131 and the second color resistor 132; and the second unit 161 includes a second color resistor portion 161a including a same material as that in one of the first color resistor 131, the second color resistor 132, and the third color resistor 141.

In the embodiments of the present disclosure, the first color resistor portion 151a in the first spacer 150 and the second color resistor portion 161a in the second spacer 160 include the same material as that in two of the first color resistor 131, the second color resistor 132 and the third color resistor 141. Thus, the first spacer 150 and the second spacer 160 can be at least partially formed simultaneously with the first color resistor layer 130 and/or the second color resistor layer 140, which is conducive to simplifying a manufacturing process, reducing a process cost and increasing a distance between the first substrate 110 and the second substrate 120.

The technical solution of the present disclosure will be described with reference to specific embodiments.

Referring to FIGS. 3 to 5, in the embodiments, in the first direction, the height of the first unit 151 is greater than the height of the second unit 161, thereby forming a height difference, which is beneficial for improving performance of the display panel 100 such as buffering properties and a quality of the display panel 100.

In the embodiments of the present disclosure, colors of the first color resistor 131, the second color resistor 132, and the third color resistor 141 are different from each other. The first color resistor 131, the second color resistor 132, and the third color resistor 141 are selected from one of a red color resistor, a green color resistor, and a blue color resistor, respectively.

In some embodiments, the display panel 100 further includes a liquid crystal layer disposed between the first substrate 110 and the second substrate 120, thereby increasing the distance between the first substrate 110 and the second substrate 120, which is conducive to increasing a thickness of the liquid crystal layer and facilitating matching with the properties of the liquid crystal material in the liquid crystal layer, and improving the performance of the display panel 100.

In some embodiments, the first unit 151 is located on the side of the first substrate 110 close to the second substrate 120. In other words, the first unit 151 and the first color resistor layer 130 are located between the liquid crystal layer and the first substrate 110. The first color resistor portion 151a including a same material as that in one of the first color resistor 131 and the second color resistor 132, so that the first color resistor portion 151a and the first color resistor layer 130 can be formed in a same process. Due to use of a color resistor material in the first color resistor portion 151a, it is prone to control a height of the first color resistor portion 151a in the first direction, thereby simplifying the manufacturing process, facilitating obtaining of the first unit 151 with a greater height in the first direction, increasing the distance between the first substrate 110 and the second substrate 120, and improving the performance of the display panel 100.

In some embodiments, the height of the first color resistor portion 151a is the maximum distance between two opposite sides of the first color resistor portion 151a in the first direction.

Referring to FIGS. 3 to 5, in some embodiments, the first unit 151 further includes a third color resistor portion 151b. The third color resistor portion 151b is located on a side of the first color resistor portion 151a close to the second substrates 120. And the third color resistor portion 151b includes a same material as that in one of the first color resistor 131 and the second color resistor 132. The first color resistor portion 151a and the third color resistor portion 151b include different materials, respectively. In the first direction, the first color resistor portion 151a and the third color resistor portion 151b are stacked, and the first color resistor portion 151a and the third color resistor portion 151b include the same materials as the first color resistor 131 and the second color resistor 132, so that the first color resistor portion 151a, the third color resistor portion 151b, the first color resistor 131, and the second color resistor 132 can be formed in the same manufacturing process. And the stacking of the first color resistor portion 151a and the third color resistor portion 151b is conducive to obtaining the first spacer 150 with a greater height in the first direction, further increasing the distance between the first substrate 110 and the second substrate 120 and improving the performance of the display panel 100.

In some embodiments, a height of the third color resistor portion 151b is the maximum distance between two opposite sides of the third color resistor portion 151b in the first direction.

In some embodiments, in the first unit 151, only the first color resistor portion 151a includes the same material as that in one of the first color resistor 131 and the second color resistor 132; alternatively, only the first color resistor portion 151a and the third color resistor portion 151b include the same materials as those in the first color resistor 131 and the second color resistor 132, and the first color resistor portion 151a and the third color resistor portion 151b include different materials, respectively. Compared with providing more color resistor portions including the same material as that in the first color resistor layer 130, providing only one color resistor portion or two stacked color resistor portions can not only reduce a difficulty of forming the first unit 151 but also facilitate a reduction of a critical dimension (CD) of the first unit 151, a reduction of area of an orthographic projection of the first spacer 150 on a first plane where the first substrate 110 is located, and an in improvement of a display effect of the display panel 100.

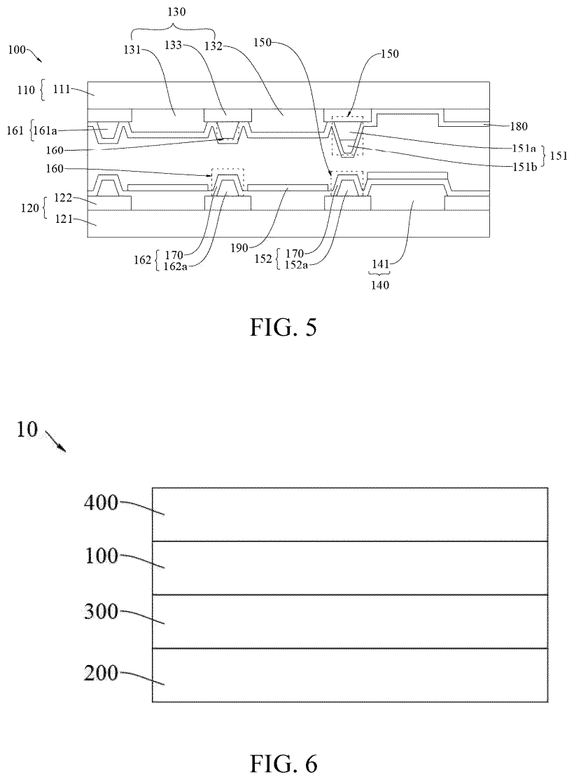

Referring to FIGS. 4 and 5, in some embodiments, the first spacer 150 further includes a third unit 152 located on the side of the second substrate 120 close to the first substrate 110. The third unit 152 is arranged corresponding to the first unit 151. The third unit 152 includes a fourth color resistor portion 152a. The fourth color resistor portion 152a includes a same material as that in the third color resistor 141. The third unit 152 and the second color resistor layer 140 are disposed between the second substrate 120 and the liquid crystal layer. The fourth color resistor portion 152a and the third color resistor 141 include the same material, so that the fourth color resistor portion 152a and the second color resistor layer 140 can be formed in a same process. Because both the fourth color resistor portion 152a and the third color resistor 141 include the same color resistor material, it is prone to control a height of the fourth color resistor portion 152a in the first direction. At the same time, the third unit 152 is arranged corresponding to the first unit 151. In other words, one first spacer 150 includes one third unit 152 and one first unit 151. The third unit 152 is arranged corresponding to the first unit 151, and an orthographic projection of the third unit 152 on the first plane and an orthographic projection of the first unit 151 on the first plane are at least partially overlap. The arrangement of the first color resistor portion 151a, the third color resistor portion 151b, and the fourth color resistor portion 152a facilitates control of heights of the first unit 151 and the third unit 152 in the first direction, which is beneficial for obtaining the first unit 151 and the third unit 152 with greater heights and improving the performance of the display panel 100.

In some embodiments, the height of the fourth color resistor portion 152a is the maximum distance between two opposite sides of the fourth color resistor portion 152a in the first direction.

Referring to FIGS. 3 to 5, in some embodiments, a distance between a side of the first unit 151 close to the second substrate 120 and a second plane (where the second substrate 120 is located) is smaller than a distance between a side of the first color resistor layer 130 close to the second substrate 120 and the second plane, thereby achieving a supporting function of the first spacer 150.

Referring to FIGS. 3 to 4, in some embodiments, the second unit 161 is located on the side of the second substrate 120 close to the first substrate 110. In other words, the second unit 161 and the second color resistor layer 140 are disposed between the liquid crystal layer and the second substrate 120. The second color resistor portion 161a includes the same material as the third color resistor 141, so that the second color resistor portion 161a and the second color resistor layer 140 can be formed in a same process. Due to the use of the color resistor material in the second color resistor portion 161a, it is prone to control a height of the second color resistor portion 161a in the first direction, thereby simplifying the manufacturing process and the control of a height difference between the second unit 161 of the second spacer 160 and the third unit 152 of the first spacer 150, improving the performance of the display panel 100.

In some embodiments, the height of the second color resistor portion 161a is the maximum distance between two opposite sides of the second color resistor portion 161a in the first direction.

Referring to FIG. 5, in some embodiments, the second unit 161 is located on the side of the first substrate 110 close to the second substrate 120. In other words, the second unit 161 and the first color resistor layer 130 are disposed between the liquid crystal layer and the first substrate 110. The second color resistor portion 161a includes the same material as that in one of the first color resistor 131 and the second color resistor 132, so that the second color resistor portion 161a and the first color resistor layer 130 can be formed in the same process. Due to the use of the color resistor material in the second color resistor portion 161a, it is prone to control the height of the second color resistor portion 161a in the first direction, thereby simplifying the manufacturing process and the control of a height difference between the second unit 161 of the second spacer 160 and the first unit 151 of the first spacer 150, improving the performance of the display panel 100.

Referring to FIGS. 3 to 4, in some embodiments, when the second unit 161 is located on the side of the second substrate 120 close to the first substrate 110, the height of the second color resistor portion 161a is equal to the height of the fourth color resistor portion 152a in the first direction. As the second color resistor portion 161a and the fourth color resistor portion 152a are made of the same material and have the same height, it facilitates a formation of the second color resistor portion 161a together with the fourth color resistor portion 152a in a same process, thereby reducing the process cost. It can be understood that, in the first direction, the height of the second color resistor portion 161a is equal to the height of the fourth color resistor portion 152a, which means that in the first direction a ratio of the height of the second color resistor portion 161a to the height of the fourth color resistor portion 152a is 0.95:1 to 1:1.05. For example, the ratio can be 0.96:1, 0.97:1, 0.98:1, 0.99:1, 1:1, 1:1.01, 1:1.02, 1:1.03, 1:1.04, etc.

Referring to FIG. 5, in some embodiments, when the second unit 161 is located on the side of said first substrate 110 close to the second substrate 120, in the first direction, the height of the second color resistor portion 161a is equal to the height of the first color resistor portion 151a, or the height of the second color resistor portion 161a is equal to the height of the third color resistor portion 151b, which facilitates a formation of the second color resistor portion 161a together with the first color resistor portion 151a or the third color resistor portion 151b in a same process, thereby reducing the process cost.

Referring to FIGS. 4 and 5, in some embodiments, the second spacer 160 further includes a fourth unit 162, and the fourth unit 162 is arranged corresponding to the second unit 161. When the second unit 161 is located on the side of the second substrate 120 close to the first substrate 110, the fourth unit 162 is located on the side of the first substrate 110 close to the second substrate 120; alternatively, when the second unit 161 is located on the side of the first substrate 110 close to the second substrate 120, the fourth unit 162 is located on the side of the second substrate 120 close to the first substrate 110. The fourth unit 162 is arranged corresponding to the second unit 161, in other words, one second spacer 160 includes one fourth unit 162 and one second unit 161. The fourth unit 162 is arranged corresponding to the second unit 161, and an orthographic projection of the fourth unit 162 on the first plane and an orthographic projection of the second unit 161 on the first plane at least partially overlap. The arrangement of the fourth unit 162 facilitates a more flexible control of a height of the second spacer 160 in the first direction, thereby simplifying the manufacturing process and the control of the height difference between the second spacer 160 and the first spacer 150, and improving the performance of the display panel 100.

In some embodiments, the fourth unit 162 includes a fifth color resistor portion 162a. When the fourth unit 162 is located on the side of the first substrate 110 close to the second substrate 120, the fifth color resistor portion 162a includes the same material as that in one of the first color resistor 131 and the second color resistor 132. For example, the fifth color resistor portion 162a includes the same material as that in the first color resistor portion 151a, and in the first direction, the height of the fifth color resistor portion 162a is equal to the height of the first color resistor portion 151a; alternatively, the fifth color resistor portion 162a includes the same material as that in the third color resistor portion 151b, and in the first direction, the height of the fifth color resistor portion 162a is equal to the height of the third color resistor portion 151b. By arranging the fifth color resistor portion 162a and the first color resistor portion 151a or the third color resistor portion 151b with the same material and the same height, it is conducive to forming the fifth color resistor portion 162a together with the first color resistor portion 151b or the third color resistor portion 151b in a same process, thereby reducing the process cost. It can be understood that, in the first direction, the height of the fifth color resistor portion 162a is equal to the height of the first color resistor portion 151a, which means that in the first direction, a ratio of the height of the fifth color resistor portion 162a to the height of the first color resistor portion 151a is 0.95:1 to 1:1.05. For example, the ratio can be 0.96:1, 0.97:1, 0.98:1, 0.99:1, 1:1, 1:1.01, 1:1.02, 1:1.03, 1:1.04, etc. Similarly, in the first direction, the height of the fifth color resistor portion 162a is equal to the height of the third color resistor portion 151b, which means that in the first direction, a ratio of the height of the fifth color resistor portion 162a to the height of the third color resistor portion 151b is 0.95:1 to 1:1.05. For example, the ratio can be 0.96:1, 0.97:1, 0.98:1, 0.99:1, 1:1, 1:1.01, 1:1.02, 1:1.03, 1:1.04, etc.

In some embodiments, the height of the fifth color resistor portion 162a is the maximum distance between two opposite sides of the fifth color resistor portion 162a in the first direction.

In some embodiments, when the fourth unit 162 is located on the side of the second substrate 120 close to the first substrate 110, the fifth color resistor portion 162a includes the same material as the third color resistor 141, so that the fifth color resistor portion 162a and the second color resistor layer 140 can be formed in a same process, and due to the use of the color resistor material in the fifth color resistor portion 162a, it is prone to control the height of the fifth color resistor portion 162a in the first direction, thereby simplifying the manufacturing process and the control of a height difference between the fourth unit 162 of the second spacer 160 and the third unit 152 of the first spacer 150, improving the performance of the display panel 100.

Referring to FIG. 5, in some embodiments, the height of the fifth color resistor portion 162a is equal to the height of the fourth color resistor portion 152a in the first direction, which facilitates a formation of them together in a same process, and reduces the process cost. It can be understood that, in the first direction, the height of the fifth color resistor portion 162a is equal to the height of the fourth color resistor portion 152a, which means that in the first direction, a ratio of the height of the fifth color resistor portion 162a to the height of the fourth color resistor portion 152a is 0.95:1 to 1:1.05. For example, the ratio can be 0.96:1, 0.97:1, 0.98:1, 0.99:1, 1:1, 1:1.01, 1:1.02, 1:1.03, 1:1.04, etc.

Referring to FIGS. 3 to 5, in some embodiments, the display panel 100 further includes a planarization layer 170 located on the side of the second substrate 120 close to the first substrate 110, and the planarization layer 170 is located on a side of the second color resistor layer 140 away from the second substrate 120. When the second color resistor portion 161a, or the fifth color resistor portion 162a is located on the side of the second substrate 120 close to the first substrate 110, the planarization layer 170 covers the second color resistor layer 140, the second color resistor portion 161a or the fifth color resistor portion 162a. When the fourth color resistor portion 152a is located on the side of the second substrate 120 close to the first substrate 110, the planarization layer 170 covers the fourth color resistor portion 152a. The planarization layer 170 is made of organic transparent material, which has leveling properties, so that the side of the second substrate 120 close to the first substrate 110 has a relatively flat surface. At the same time, due to a flattening effect of the material of the planarization layer 170, compared with arranging multiple stacked color resistor portions on one side of the second substrate 120, arranging a single second color resistor portion 161a, a single fourth color resistor portion 152a, or a single fifth color resistor portion 162a is more advantageous in reducing the critical dimensions of the second color resistor portion 161a, the fourth color resistor portion 152a, or the fifth color resistor portion 162a, thereby reducing an orthogonal projection area of the first spacer 150 and/or the second spacer 160 on the first plane and improving the display effect of the display panel 100.

In some embodiments, when the second unit 161 is located on the side of the second substrate 120 close to the first substrate 110, the planarization layer 170 further includes a first flat part located in the second unit 161, then the second unit 161 includes the second color resistor portion 161a and the first flat part.

In some embodiments, when the third unit 152 is located on the side of the second substrate 120 close to the first substrate 110, the planarization layer 170 further includes a second flat part located in the third unit 152, then the third unit 152 includes the fourth color resistor portion 152a and the second flat part.

In some embodiments, when the fourth unit 162 is located on the side of the second substrate 120 close to the first substrate 110, the planarization layer 170 further includes a third flat part located in the fourth unit 162, then the fourth unit 162 includes the fifth color resistor portion 162a and the third flat part.

Referring to FIGS. 3 to 5, in some embodiments, when the second unit 161 or the fourth unit 162 is located on the side of the second substrate 120 close to the first substrate 110, the distance between a side of the second unit 161 or the fourth unit 162 away from the second substrate 120 and the first plane is smaller than the distance between the side of the second color resistor layer 140 away from the second substrate 120 and the first plane, thereby achieving an auxiliary supporting function of the second spacer 160.

In some embodiments, the first spacer 150 includes the first unit 151, or the first spacer 150 includes the first unit 151 and the third unit 152. The second spacer 160 includes the second unit 161, or the second spacer 160 includes the second unit 161 and the fourth unit 162.

Referring to FIGS. 3 to 5, in some embodiments, the first color resistor layer 130 further includes at least one black matrix 133 surrounding each of the first color resistor 131 and the second color resistor 132. The black matrix 133 surrounds an orthographic projection of the third color resistor 141 on the first color resistor layer 130. An orthographic projection of the first spacer 150 on the first color resistor layer 130 is within the black matrix 133, and an orthographic projection of the second spacer 160 on the first color resistor layer 130 is within the black matrix 133.

In some embodiments, the orthographic projections of a plurality of the first spacers 150 on the first substrate 110 are uniformly distributed, which is beneficial for controlling a uniformity of the spacing between the first substrate 110 and the second substrate 120. The orthographic projections of a plurality of second spacers 160 on the first substrate 110 are uniformly distributed, which is beneficial for controlling a uniformity of the buffering performance of the display panel 100.

In some embodiments, the first substrate 110 is a color film substrate, and the second substrate 120 is an array substrate. Alternatively, the first substrate 110 is the array substrate, and the second substrate 120 is the color film substrate.

Referring to FIGS. 3 to 5, in some embodiments, the first substrate 110 is the color film substrate. The color film substrate includes a first supporting base 111, and the first color resistor layer 130 is located on a side of the first supporting base 111 close to the second substrate 120. The display panel 100 further includes a common electrode layer 180 located on the sides of the first color resistor layer 130 and the first unit 151 close to the second substrate 120. When the second unit 161 or the fourth unit 162 is located on the side of the first supporting base 111 close to the second substrate 120, the common electrode layer 180 covers the second unit 161 or the fourth unit 162.

Referring to FIGS. 3 to 5, in some embodiments, the second substrate 120 is the array substrate. The array substrate includes a second supporting base 121, and a thin film transistor layer disposed between the second supporting base 121 and the planarization layer 170. The thin film transistor layer includes a plurality of thin film transistors 122. The third color resistor 141 is located between the adjacent thin film transistors 122, an orthographic projection of the first color resistor 131 in the thin film transistor layer is located between the adjacent thin film transistors 122, and an orthographic projection of the second color resistor 132 in the thin film transistor layer is located between the adjacent thin film transistors 122. A plurality of thin film transistors 122 are arranged in an array along a row direction and a column direction. On the first plane, the orthographic projection of the first color resistor 131, the orthographic projection of the second color resistor 132, and the orthographic projection of the third color resistor 141 are alternately arranged along the row direction or the column direction.

In some embodiments, the thin film transistor 122 includes an active layer, a gate electrode, a source electrode, and a drain electrode. The source electrode and the drain electrode can be disposed in a same layer on a side of the active layer close to the first substrate 110. The gate electrode can be disposed between the source electrode and the drain electrode and the gate electrode can be located on the side of the active layer close to the first substrate 110; alternatively, the gate electrode can be located on a side of the active layer close to the second supporting base 121; alternatively, the gate electrode includes a first sub-gate electrode and a second sub-gate electrode, and the first sub-gate electrode and the second sub-gate electrode are respectively located on one side of the active layer close to the second supporting base 121 and the other side of the active layer away from the second supporting base 121.

Referring to FIGS. 3 to 5, in some embodiments, the display panel 100 further includes a plurality of pixel electrodes 190. The plurality of pixel electrodes 190 include at least one first sub-pixel electrode, at least one second sub-pixel electrode, and at least one third sub-pixel electrode. The first sub-pixel electrode and the first color resistor 131 are arranged in one-to-one correspondence. The second sub-pixel electrode and the second color resistor 132 are arranged in one-to-one correspondence. The third sub-pixel electrode and the third color resistor 141 are arranged in one-to-one correspondence.

Referring to FIGS. 3 to 5, in some embodiments, the third unit 152 is located between the adjacent pixel electrodes 190. When the second unit 161 or the fourth unit 162 is located on the side of the substrate 120 close to the first substrate 110, the second unit 161 or the fourth unit 162 is located between the adjacent pixel electrodes 190.

In the embodiments of the present disclosure, the first color resistor portion 151a in the first spacer 150 and the second color resistor portion 161a in the second spacer 160 include the same material as those in two of the first color resistor 131, the second color resistor 132, and the third color resistor 141. The first spacer 150 and the second spacer 160 can be at least partially formed simultaneously with the first color resistor layer 130 and/or the second color resistor layer 140, which is conducive to simplifying the manufacturing process and reducing the process cost, and facilitates increasing the distance between the first substrate 110 and the second substrate 120.

Referring to FIG. 6, embodiments of the present disclosure further provide a display device 10 including a display panel 100 as previously described.

For the specific structure of the display panel 100, please refer to any of the above embodiments of the display panel 100 and the accompanying drawings, which will be omitted here.

Referring to FIG. 6, in some embodiments, the display device 10 further includes a backlight module 200. The backlight module 200 can be located on a side of the first substrate 110 away from the second substrate 120; alternatively, the backlight module 200 can be located on a side of the second substrate 120 away from the first substrate 110.

Referring to FIG. 6, in some embodiments, the display device 10 further includes a first polarizer 300 and a second polarizer 400. The first polarizer 300 can be disposed between the display panel 100 and the backlight module 200, and the second polarizer 400 can be disposed on a side of the display panel 100 away from the backlight module 200.

The present disclosure discloses a display panel and a display device. The display panel includes a first substrate and a second substrate arranged oppositely, a first color resistor layer, a second color resistor layer, at least one first spacer, and at least one second spacer arranged between the first and second substrates. The first color resistor layer includes at least one first color resistor and at least one second color resistor. The second color resistor layer includes at least one third color resistor. The first spacer includes a first unit located on a side of the first substrate close to the second substrate, and a first color resistor portion of the first unit includes a same material as that in one of the first color resistor and the second color resistor. The second spacer includes a second unit, which includes a second color resistor portion having a same material as that in one of the first color resistor, the second color resistor and the third color resistor. In the present disclosure, the first color resistor portion and the second color resistor portion include the same materials as those in two of the first color resistor, the second color resistor and the third color resistor, so that the first spacer and the second spacer can be at least partially formed simultaneously with the first color resistor layer and/or the second color resistor layer, which is conducive to simplifying a manufacturing process and reducing a process cost, and facilitates increasing a distance between the first substrate and the second substrate.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A display panel, comprising:
a first substrate;
a second substrate arranged opposite to the first substrate;
a first color resistor layer located on a side of the first substrate close to the second substrate, the first color resistor layer comprising at least one first color resistor and at least one second color resistor;
a second color resistor layer located on a side of the second substrate close to the first substrate, the second color resistor layer comprising at least one third color resistor;
at least one first spacer arranged between the first substrate and the second substrate, the first spacer comprising a first unit located on the side of the first substrate close to the second substrate; and
at least one second spacer arranged between the first substrate and the second substrate, the second spacer comprising a second unit,
wherein in a first direction perpendicular to each of the first substrate and the second substrate, a height of the first unit is greater than a height of the second unit; and
the first unit comprises a first color resistor portion comprising a same material as that in one of the first color resistor and the second color resistor, and the second unit comprises a second color resistor portion comprising a same material as that in one of the first color resistor, the second color resistor, and the third color resistor.

2. The display panel of claim 1, wherein the second unit is located on the side of the second substrate close to the first substrate, and the second color resistor portion comprises the same material as that in the third color resistor.

3. The display panel of claim 2, wherein the first unit further comprises a third color resistor portion located on a side of the first color resistor portion close to the second substrate and comprising a same material as that in one of the first color resistor and the second color resistor; and
the first color resistor portion comprises a different material from that in the third color resistor portion.

4. The display panel of claim 3, wherein the first spacer further comprises a third unit located on the side of the second substrate close to the first substrate and arranged corresponding to the first unit; and
the third unit comprises a fourth color resistor portion comprising a same material as that in the third color resistor.

5. The display panel of claim 4, wherein in the first direction, a height of the second color resistor portion is equal to a height of the fourth color resistor portion.

6. The display panel of claim 4, wherein the second spacer further comprises a fourth unit located on the side of the first substrate close to the second substrate and arranged corresponding to the second unit; and
the fourth unit comprises a fifth color resistor portion comprising a same material as that in one of the first color resistor and the second color resistor.

7. The display panel of claim 6, wherein the fifth color resistor portion comprises the same material as that in the first color resistor portion; and
in the first direction, a height of the fifth color resistor portion is equal to a height of the first color resistor portion.

8. The display panel of claim 6, wherein the fifth color resistor portion comprises the same material as that in the third color resistor portion; and
in the first direction, a height of the fifth color resistor portion is equal to a height of the third color resistor portion.

9. The display panel of claim 1, wherein the second unit is located on the side of the first substrate close to the second substrate, and the second color resistor portion comprises the same material as that in one of the first color resistor and the second color resistor.

10. The display panel of claim 1, wherein the first color resistor layer further comprises at least one black matrix surrounding each of the first color resistor and the second color resistor and surrounding an orthographic projection of the third color resistor on the first color resistor layer; and
an orthographic projection of the first spacer on the first color resistor layer is within the black matrix, and an orthographic projection of the second spacer on the first color resistor layer is within the black matrix.

11. A display device comprising a display panel, the display panel comprising:
a first substrate;
a second substrate arranged opposite to the first substrate;
a first color resistor layer located on a side of the first substrate close to the second substrate, the first color resistor layer comprising at least one first color resistor and at least one second color resistor;
a second color resistor layer located on a side of the second substrate close to the first substrate, the second color resistor layer comprising at least one third color resistor;
at least one first spacer arranged between the first substrate and the second substrate, the first spacer comprising a first unit located on the side of the first substrate close to the second substrate; and
at least one second spacer arranged between the first substrate and the second substrate, the second spacer comprising a second unit,
wherein in a first direction perpendicular to each of the first substrate and the second substrate, a height of the first unit is greater than a height of the second unit; and
the first unit comprises a first color resistor portion comprising a same material as that in one of the first color resistor and the second color resistor, and the second unit comprises a second color resistor portion comprising a same material as that in one of the first color resistor, the second color resistor, and the third color resistor.

12. The display device of claim 11, wherein the second unit is located on the side of the second substrate close to the first substrate, and the second color resistor portion comprises the same material as that in the third color resistor.

13. The display device of claim 12, wherein the first unit further comprises a third color resistor portion located on a side of the first color resistor portion close to the second substrate and comprising a same material as that in one of the first color resistor and the second color resistor; and
the first color resistor portion comprises a different material from that in the third color resistor portion.

14. The display device of claim 13, wherein the first spacer further comprises a third unit located on the side of the second substrate close to the first substrate and arranged corresponding to the first unit; and
the third unit comprises a fourth color resistor portion comprising a same material as the third color resistor.

15. The display device of claim 14, wherein in the first direction, a height of the second color resistor portion is equal to a height of the fourth color resistor portion.

16. The display device of claim 14, wherein the second spacer further comprises a fourth unit located on the side of the first substrate close to the second substrate and arranged corresponding to the second unit; and
the fourth unit comprises a fifth color resistor portion comprising a same material as that in one of the first color resistor and the second color resistor.

17. The display device of claim 16, wherein the fifth color resistor portion comprises the same material as that in the first color resistor portion; and
in the first direction, a height of the fifth color resistor portion is equal to a height of the first color resistor portion.

18. The display device of claim 16, wherein the fifth color resistor portion comprises the same material as that in the third color resistor portion; and
in the first direction, a height of the fifth color resistor portion is equal to a height of the third color resistor portion.

19. The display device of claim 11, wherein the second unit is located on the side of the first substrate close to the second substrate, and the second color resistor portion comprises the same material as that in one of the first color resistor and the second color resistor.

20. The display device of claim 11, wherein the first color resistor layer further comprises at least one black matrix surrounding each of the first color resistor and the second color resistor and surrounding an orthographic projection of the third color resistor on the first color resistor layer; and
an orthographic projection of the first spacer on the first color resistor layer is within the black matrix, and an orthographic projection of the second spacer on the first color resistor layer is within the black matrix.
